(19) United States
(12) Patent Application Publication
(10) Pub. No.: US 2013/0047776 A1
(43) Pub. Date: Feb. 28, 2013

(54) DRIVE PEDAL UNIT FOR MOTOR VEHICLES

(71) Applicants: Carmelo Leone, Freising (DE); Andreas Zell, Nurnberg (DE); Mihaly Szasz, Bahnea (RO); Mihai Duca, Sibiu (RO); Ciprian Dragoi, Selimbar (RO)

(72) Inventors: Carmelo Leone, Freising (DE); Andreas Zell, Nurnberg (DE); Mihaly Szasz, Bahnea (RO); Mihai Duca, Sibiu (RO); Ciprian Dragoi, Selimbar (RO)

(21) Appl. No.: 13/696,407

(22) PCT Filed: May 10, 2011
(86) PCT No.: PCT/EP11/57514

§ 371 Date: Nov. 6, 2012

(30) Foreign Application Priority Data
May 11, 2010 (DE) 102-010-020-242.8
Oct. 6, 2010 (DE) 10-2010-042-037.9

(51) Int. Cl. G05G 1/44

(52) U.S. Cl. 74/513

(57) ABSTRACT

A drive pedal unit for motor vehicles, wherein a position change of the pedal plate brought about by a corresponding actuating force, with respect to the starting position thereof against a restoring force of a restoring spring, leads to an increase of the drive force of the engine and, when the actuating force decreases, the restoring force of the restoring spring returns the pedal plate in the direction of the starting position thereof. An externally controllable electro-mechanical actuator is arranged such that an additional restoring force may be set on the pedal plate. A hysteresis of the pedal characteristic curve is produced and is independent of the additional restoring force of the electromechanical actuator. A friction surface cooperates with a friction element, wherein the friction surface is connected to the pedal plate, whilst the friction element is decoupled from the power flow between the pedal plate and the electromechanical actuator.

### CROSS REFERENCE TO RELATED APPLICATIONS

This application is the U.S. National Phase Application of PCT International Application No. PCT/EP2011/057514, filed May 10, 2011, which claims priority to German Patent Application No. 10 2010 020 242.8, filed May 11, 2010, and German Patent Application No. 10 2010 042 037.9, filed Oct. 6, 2010, the contents of such applications being incorporated by reference herein.

### FIELD OF THE INVENTION

The present invention relates to a drive pedal unit for motor vehicles, wherein a position change of the pedal plate brought about by a corresponding actuating force, with respect to the starting position thereof against a restoring force of a restoring spring, leads to an increase of the drive force of the engine and, when the actuating force decreases, the restoring force of the restoring spring returns the pedal plate in the direction of the starting position thereof, wherein an externally controllable electromechanical actuator is arranged such that an additional restoring force may be set on the pedal plate.

### BACKGROUND OF THE INVENTION

The problem generally exists in modern motor vehicles that the vehicle driver is supplied with a lot of information about the motor vehicle. This sensory overload of the vehicle driver by acoustic and optical signals results in the driver becoming distracted from the traffic. As a result, the vehicle driver tends to fail to hear or ignore signals or is no longer able to assign the signals to the cause thereof. A drive pedal unit of the type mentioned in the introduction avoids all the drawbacks of optical and acoustic systems: it is a human-machine interface suitable for longitudinal dynamic functions (distance information, speed limits and speed control) as well as for displaying danger warnings.

The passive pedal characteristic curve of a drive pedal generally has a hysteresis. A method and a device for producing a pedal characteristic curve is disclosed in WO2005/105508A1, which is incorporated by reference. In the hitherto known device, it is proposed to produce the hysteresis by means of the electromechanical actuator. To this end, however, the electromechanical actuator has to be controlled with each actuation of the drive pedal and, at the same time, when an additional restoring force is generated by the electromechanical actuator a superposition control has to be calculated.

### SUMMARY OF THE INVENTION

An aspect of the present invention, therefore, is to improve a drive pedal unit of the type mentioned in the introduction so that the forces of the passive pedal characteristic curve and of the electromechanical actuator do not mutually influence one another.

According to an aspect of the invention, this is achieved by a device wherein hysteresis means are provided for producing a hysteresis of the pedal characteristic curve, and wherein the hysteresis is independent of the additional restoring force (F_{Additional}) of the electromechanical actuator. In this case, hysteresis means are provided for producing a hysteresis of the pedal characteristic curve, wherein the hysteresis is independent of the additional restoring force of the electromechanical actuator.

In an advantageous development of the subject of the invention, it is provided that the hysteresis means are designed as a friction element and a friction surface cooperating with the friction element, wherein the friction surface is connected to the pedal plate, whilst the friction element is decoupled from the power flow between the pedal plate and the electromechanical actuator.

In a further advantageous development, the friction element is movably arranged about an axis, which is located parallel to the axis of the friction surface. To this end, the friction element is pivotably arranged about an axle pin, wherein the axle pin is fastened in a housing of the drive pedal unit.

In a first alternative, the electromechanical actuator is configured as a linear lifting magnet, the plunger thereof bearing against a cam-like cam disk, wherein the cam disk is able to be actuated by means of a transmission element of the pedal plate.

An advantageous development provides that the cam-like cam disk carries at least one magnet, the motion thereof being able to be determined by a sensor.

In a second alternative embodiment, the electromechanical actuator is configured as an adjustable electric motor, which pretensions a torsion spring against a bearing pin, wherein a lever arm connected to the pedal plate bears against the bearing pin.

An advantageous development provides that the lever arm carries at least one magnet, the motion thereof being able to be determined by a sensor.

In a third alternative embodiment, the electromechanical actuator is configured as a reversible electric motor, a pretensioned belt being located on the motor shaft thereof, said belt, on the one hand, being connected via a pretensioned spring to a housing of the drive pedal unit and, on the other hand, to a cam disk, wherein the cam disk is able to be actuated by means of a transmission element of the pedal plate.

In all alternative embodiments it is provided that the additional restoring force limits the maximum stroke of the pedal plate, and generates force impulses or vibrations on the pedal plate.

### BRIEF DESCRIPTION OF THE DRAWINGS

The invention is best understood from the following detailed description when read in connection with the accompanying drawings. Included in the drawings is the following figures:

FIG. 1 shows a sectional view of a first exemplary embodiment of the drive pedal unit according to aspects of the invention;

FIG. 2 shows a plan view in a partial sectional view of the drive pedal unit of FIG. 1;

FIG. 3 shows a pedal characteristic curve;

FIG. 4 shows a further sectional view of the first exemplary embodiment of FIG. 1;

FIG. 5 shows a three-dimensional view of a second exemplary embodiment of the drive pedal unit according to aspects of the invention;

FIGS. 6a, b show two partial views of selected components of the drive pedal unit of FIG. 5;

FIG. 7 shows a further partial view of the drive pedal unit of FIG. 5;

FIGS. 8a, b show an exploded view of the components shown in FIG. 7;

FIG. 9 shows a sectional view of a third exemplary embodiment of the drive pedal unit according to aspects of the invention;

FIG. 10 shows a further sectional view of the drive pedal unit shown in FIG. 9 and

FIG. 11 shows a pedal characteristic curve for illustrating the mode of operation of all embodiments.

### DETAILED DESCRIPTION OF PREFERRED EMBODIMENTS

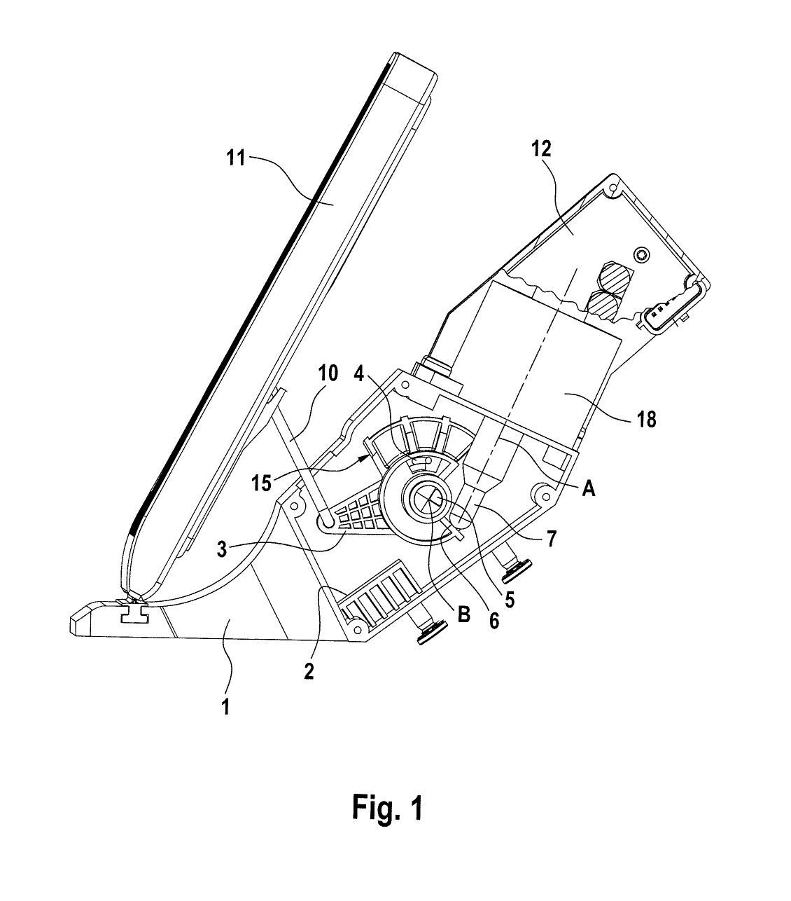

A drive pedal unit 1 for motor vehicles is shown in FIG. 1. If the vehicle driver steps on a pedal plate 11 of the drive pedal unit 1, and sets a position change of the pedal plate 11 brought about by a corresponding foot actuating force, with respect to the starting position thereof against a restoring force F_{Restoring}, this leads to an increase in the drive force of the drive motor of the motor vehicle. In this case, it is insignificant whether the drive motor of the motor vehicle is implemented by an internal combustion engine or one or more electric motors or by a combination of the aforementioned motors. If the vehicle driver releases his/her foot from the pedal plate 11, a restoring force F_{Restoring} returns the pedal plate 11 in the direction of the starting position thereof. This restoring force F_{Restoring} is produced by a restoring spring, not shown here. In the drive pedal unit shown in FIG. 1, an additional restoring force F_{Additional} may be produced on the pedal plate 11, if required. In this manner, the vehicle driver obtains haptic information. Thus, for example, the economic and fuel-saving operation of the motor vehicle may be maintained by the additional restoring force F_{Additional} being increased in the case of inefficient engine speed and thus the pedal sensation becoming harder. On the other hand, the maximum stroke S of the pedal plate 11 may be limited as will be explained below in more detail. Other haptic information which may be transmitted to the vehicle driver also includes the transmission of safety-critical information, such as insufficient distance from the vehicle driving ahead.

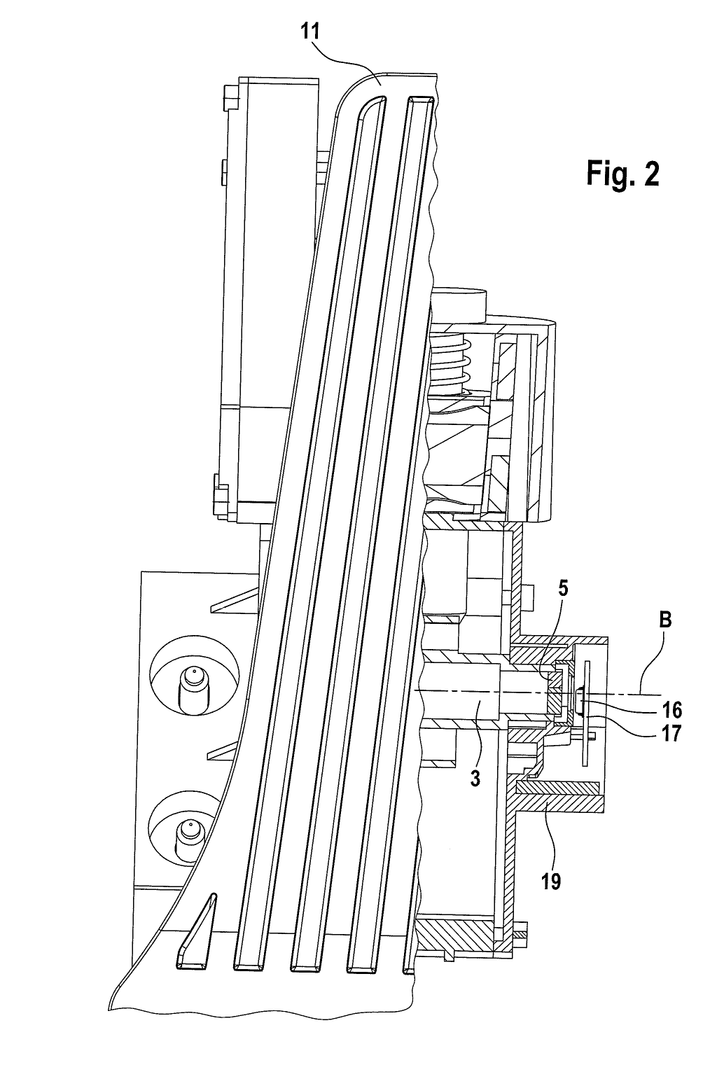

If the pedal plate 11 is depressed, it rotates about its rotational axis. The pedal plate 11 actuates a transmission element 10 which in turn is connected to a cam-like cam disk 3. By means of the force transmission from the pedal plate 11 via the transmission element 10 to the cam disk 3, said cam disk is rotated about an axis B. An electromechanical actuator, which in the present exemplary embodiment is configured as a lifting magnet 18, also acts on the cam-like cam disk 3: the magnet plunger 7 of the lifting magnet 18 bears against a bearing surface 6 of the cam disk 3 and is movable along an axis A of the lifting magnet 18. As the magnet plunger 7 is only able to bear against the bearing surface 6, the lifting magnet 18 in this case is only able to produce a force in the direction of restoring the pedal plate 11. The lifting magnet 18 is not able to produce a more powerful actuation of the pedal plate 11 than that set by the vehicle driver by means of foot force. It thus exclusively acts in the restoring direction with the additional restoring force F_{Additional}. With the actuation of the pedal plate 11, the cam disk 3 together with a magnet 5 are set in rotational motion about the axis B. A sensor 16 shown in FIG. 2, which is connected to a control unit 17, determines the position of the pedal plate 11 by means of the magnet 5, which is moved together with the cam disk 3. If an additional restoring force F_{Additional} is to be produced, a further control unit 12 emits an electrical signal to the lifting magnet 18. The lifting magnet 18 is a non-commutated direct drive with a limited stroke S, which comprises the magnet plunger 7 and a static coil for providing the Lorentz force. The lifting magnet 18 may be controlled by means of electrical signals from the control unit 12 so that the additional restoring force F_{Additional} may be felt by the vehicle driver as a vibration or force impulse on the pedal plate 11. Depending on the numerous aforementioned functions of the type of force of the additional restoring force F_{Additional}, both the degree of additional restoring force F_{Additional} may be set or the maximum stroke S of the pedal plate 11 limited. As is visible from FIG. 1, the maximum stroke S of the pedal plate 11 is reached when the cam disk 3 bears against a stop 2. Even before this maximum possible stroke S, the stroke S of the pedal plate 11 may be limited by a correspondingly large restoring force F_{Additional} of the lifting magnet 18. The vehicle driver then feels a force threshold on the pedal plate 11 which is only able to be overcome by a greater expenditure of force. In this manner, the maximum possible stroke S of the pedal plate 11 is limited. This function may be used to guide the vehicle driver in an energy-saving driving mode.

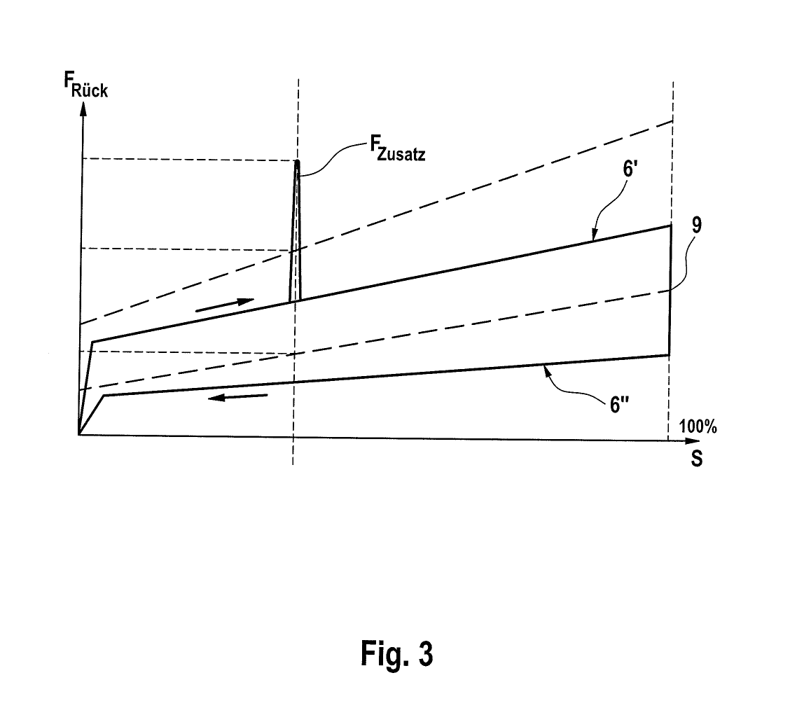

The characteristic curve required for a drive pedal unit 1 is described below with reference to FIG. 3. The stroke S of the pedal plate 11 is plotted on the abscissa, wherein the maximum possible stroke S, which is defined by the contact between the cam disk 3 and the bearing surface 2, is on the abscissa at 100%. The ordinate represents the restoring force F_{Restoring} and/or the additional restoring force F_{Additional} on the pedal plate 11. In order to increase the speed of the motor vehicle, the vehicle driver exerts a force on the pedal plate 11. By increasing the angle about which the pedal plate 11 is deflected, the speed of the motor vehicle increases. In order to convey to the vehicle driver the sensation that he/she is controlling the speed, the pedal plate 11 increases the restoring force F_{Restoring} against the foot of the vehicle driver with an increasing pedal angle and/or increasing pedal stroke. This restoring force F_{Restoring} in conventional pedal arrangements is produced by a restoring spring and a hysteresis spring. If the force which is exerted by the vehicle driver on the pedal plate 11 and the restoring force F_{Restoring} which is produced by the restoring spring and the hysteresis spring are in equilibrium, the sensation is conveyed to the vehicle driver, in particular on a flat road surface, that he/she is moving forwards at constant speed.

The characteristic curve 6′, 6″ of the pedal plate 11 shows the path of the restoring force F_{Restoring} as a function of the pedal stroke S. In FIG. 3, the outgoing characteristic curve 6′ represents the increase in speed. The initial counterforce when the pedal stroke S is equal to zero and the gradient in the outgoing characteristic curve 6′ are determined in conventional pedal arrangements by the choice of restoring spring and hysteresis spring. If the vehicle driver wishes to reduce the speed of the motor vehicle, he/she reduces the force on the pedal plate 11. As soon as the direction of the pedal deflection is reversed in the direction of the decreasing pedal stroke S, in hitherto known systems the hysteresis spring is disconnected, for example by uncoupling the corresponding spring. The restoring force F_{Restoring} with which the pedal plate 11 acts on the foot of the vehicle driver, is now reduced by the amount which is produced by the hysteresis spring. This reduction in the restoring force F_{Restoring} with a reversal of the pedal angle is illustrated by the so-called hysteresis jump 9. The counterforce of the returning characteristic curve 6″ is now plotted solely by the aforementioned restoring spring. When the vehicle driver wishes to reduce the speed, he/she decreases the force on the pedal plate 11. The restoring force F_{Restoring} exerted by the restoring spring causes the pedal plate 11 to remain in contact with the foot of the vehicle driver and the sensation is conveyed to the vehicle driver that he/she is actively controlling the vehicle to reduce the speed. An additional restoring force F_{Additional} is shown in FIG. 3 by way of example as a force peak which indicates a force threshold for the vehicle driver when the pedal plate 11 is depressed.

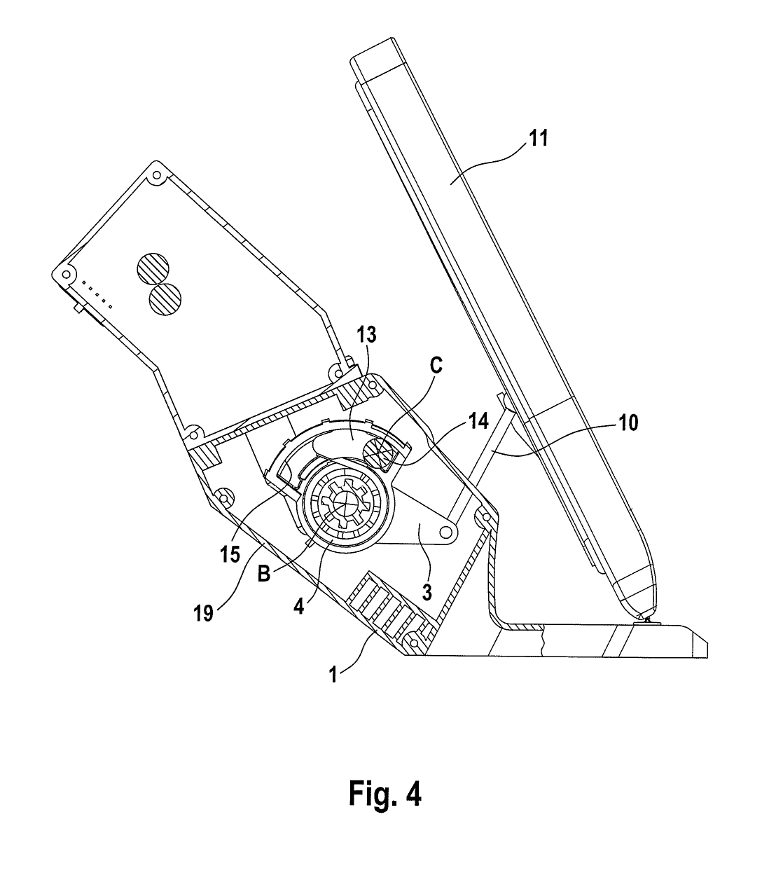

In contrast to conventional pedal arrangements, in the present drive pedal unit 1 it is now provided that hysteresis means produce the hysteresis of the pedal characteristic curve, wherein said hysteresis is independent of the additional restoring force F_{Additional} of the lifting magnet 18. The required hysteresis is produced by the hysteresis means shown in FIG. 4. The idea of the invention is that the hysteresis is independent of the additional restoring force F_{Additional} of the lifting magnet 18. The hysteresis means are configured in the exemplary embodiment shown in FIG. 4 as a friction element 13 and a friction surface 15 cooperating with the friction element 13. The friction surface 15 is fixedly connected to the cam-like cam disk 3 and is located in the radial direction relative to the rotational axis B of the cam disk 3. By means of the fixed connection, the friction surface 15 is rotated together with the cam disk 3 about the rotational axis B. As the cam disk 3 is connected via the transmission element 10 to the pedal plate 11, a frictional force applied to the friction surface 15 is transmitted to the movement of the pedal plate 11 i.e. such a frictional force damps the movement of the pedal plate 11. A friction element 13 cooperates with the friction surface 15, said friction element being pivotably mounted about an axle pin 14. The rotational axis C of the axle pin 14 is arranged in parallel and spaced apart from the rotational axis B of the cam disk 3. The axle pin 14 is fastened in the housing 19. A torsion spring 4 presses the friction element 13 against the friction surface 15 and, with the movement of the friction surface 15 which rotates together with the pedal plate 11, generates a frictional force. As a result, the hysteresis of the pedal characteristic curve is produced. In comparison with FIG. 1 and FIG. 4, it is clear that the hysteresis is produced independently of the additional restoring force F_{Additional} of the electromechanical actuator: the friction surface 15 and the friction element 13 for producing the hysteresis are not arranged in the power flow between the lifting magnet 18 and the cam disk 3, but parallel relative to said power flow and, therefore, independent of the additional restoring force F_{Additional} produced by the lifting magnet 18. The important factor here is that the hysteresis remains constant—irrespective of whether the lifting magnet 18 is controlled or not. As a result, the drive pedal unit 1 conveys an improved sensation to the vehicle driver when the hysteresis behavior remains consistent, irrespective of whether the lifting magnet 18 is active or is not activated.

As may be further derived from FIG. 1, the torsion spring 4 is suspended in the cam disk 3 and is tensioned by a rotation of the cam disk 3. The other end of the torsion spring 4 bears against the friction element 13 and presses it against the friction surface 15. By the rotation of the cam disk 3, the torsion spring 4 is increasingly tensioned and presses the friction element 13 more firmly against the friction surface 15. A hysteresis jump is produced between the outgoing and returning characteristic curves, as has been described with reference to FIG. 3, because the frictional loss acts in the actuating direction and thus is added to the foot actuation force when the pedal plate 11 is depressed, whilst when the pedal plate 11 is released the frictional loss acts in the opposing direction.

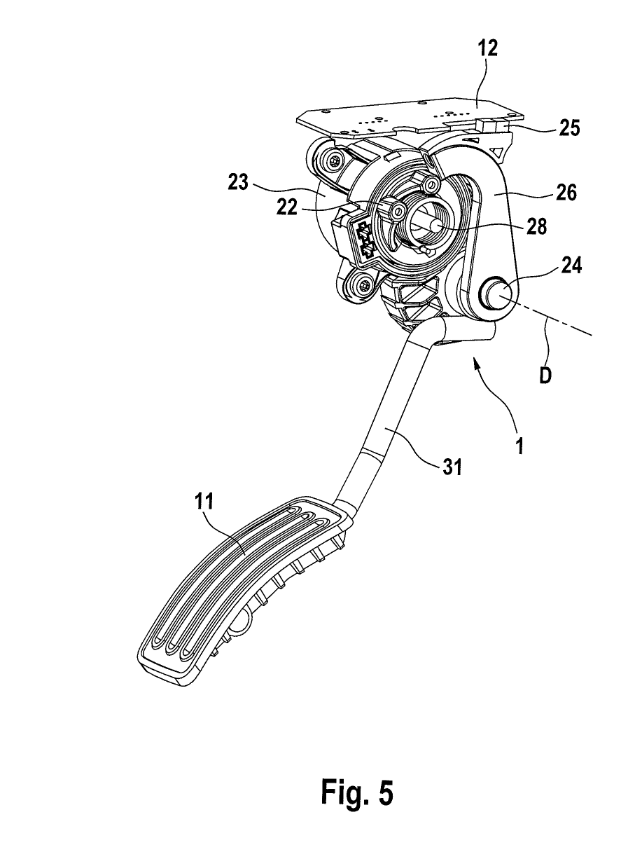

With reference to FIGS. 5 to 8, the hysteresis means are described in the case of a suspended drive pedal unit 1. The same elements which are present in the drive pedal unit shown with reference to FIGS. 1 to 4 are denoted by the same reference numerals. The drive pedal unit 1 shown in FIG. 5 is also able to generate an additional restoring force F_{Additional}, in order to transmit haptic information to the vehicle driver. In order to transmit such haptic information to the vehicle driver, an electrical signal from an external control unit within the motor vehicle is converted by a control unit 12 of the drive pedal unit 1.

The pedal plate 11 in the suspended pedal is connected to a pedal lever 31. If the pedal plate 11 is depressed, it rotates a lever arm 26 connected to the pedal plate 11 about its rotational axis D. The rotational axis D is formed by the main shaft 24. As a result, the lever 26 together with a magnet 25 is set in rotational motion about the rotational axis D. A sensor which is connected to the control unit 12 determines the position of the pedal plate 11 by means of the magnet 25, which rotates together with the lever arm 26. The lever arm 26 bears against a bearing pin 22, the position thereof being shown twice in FIG. 5, in order to illustrate the movement of the pedal unit 1. If the drive pedal unit 1 is to generate an additional restoring force F_{Additional}, then the control unit 12 controls an electric motor 23 and the bearing pin 22 completes a part of the movement together with a motor shaft 28 of the electric motor 23. When the electric motor 23 is operated, the motor shaft 28 starts to rotate and the lever arm 26 is moved by the movement of the bearing pin 22. In this manner, the restoring force which may be felt by the vehicle driver on the pedal plate 11 is increased. Depending on the plurality of functions of the drive pedal unit 1, this additional restoring force may be modified and the electric motor 23 may generate warning vibrations or rectangular force impulses. In this case, two successive rectangular force impulses have proved particularly effective.

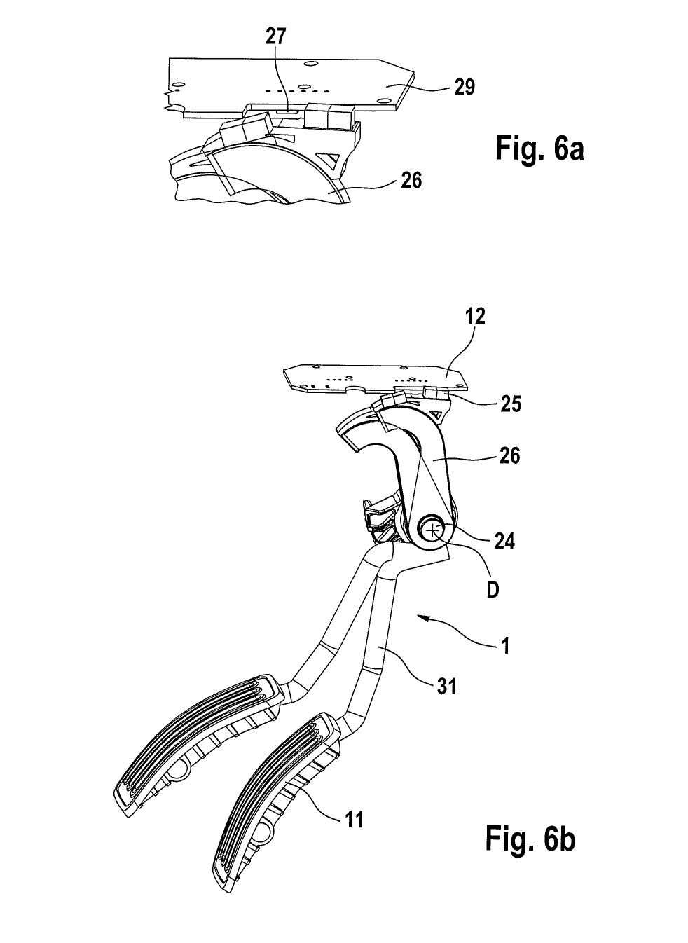

In FIGS. 6a and 6b two actuating positions of the drive pedal 1 are shown, in turn. For detecting the pedal plate position, the lever arm 26 carries a magnet 25, the movement thereof being detected by a sensor 27. The magnet 25 cooperates with the sensor 27 configured as the magnetic field sensor. A Hall element or a magneto-resistive element are considered as magnetic field sensors. For reasons of redundancy, the sensor 27 has two detection elements. As may be derived from FIGS. 6a and 6b, the sensor 27 is integrated in the control unit 12, i.e. a specific signal transmission between the control unit 12 and the sensor 27 is not required as the sensor 27 is already arranged on the circuit board 29 of the control unit 12.

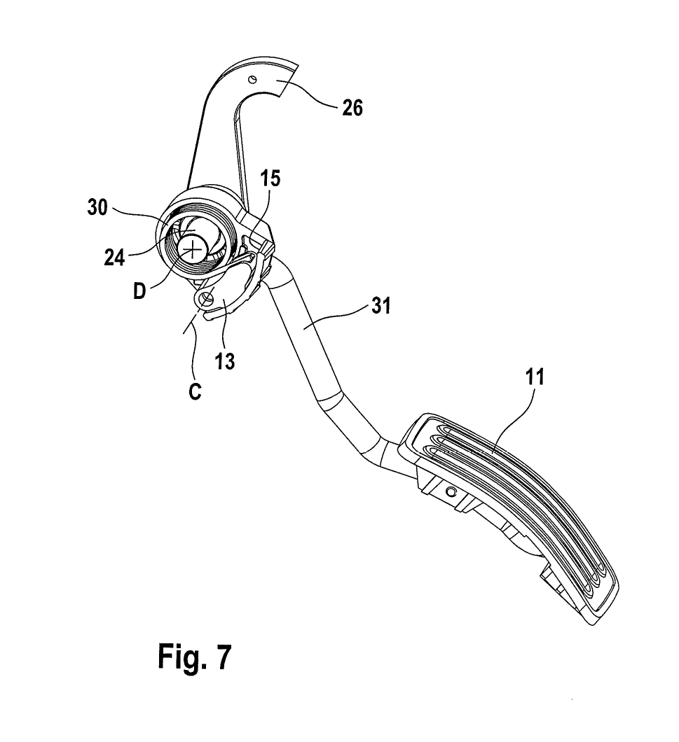

The means for generating a hysteresis, which is applied independently of the electric motor 23, are shown in FIG. 7; a friction surface 15 is fixedly connected to the lever arm 26. The friction element 13 which cooperates with the friction surface 15 is pivotably mounted about an axis C. A pin is arranged in the axis C, said pin being fastened in a housing and bearing the friction element 13. The friction element 13 is pretensioned by a spring 30 against the friction surface 15. As the friction surface 15 is fixedly connected to the lever arm, a frictional force on the friction surface 15 also acts on the lever arm and thus on the pedal plate 11. As already explained with reference to the exemplary embodiment of FIGS. 1 to 4, and in the exemplary embodiment of FIGS. 5 to 8, the means for generating the hysteresis are decoupled from the power flow of the electric motor 23 via the torsion spring, not shown, relative to the bearing pin 22. The generation means in the form of the friction surface 15 and the friction element 13 are instead arranged in parallel with this power flow.

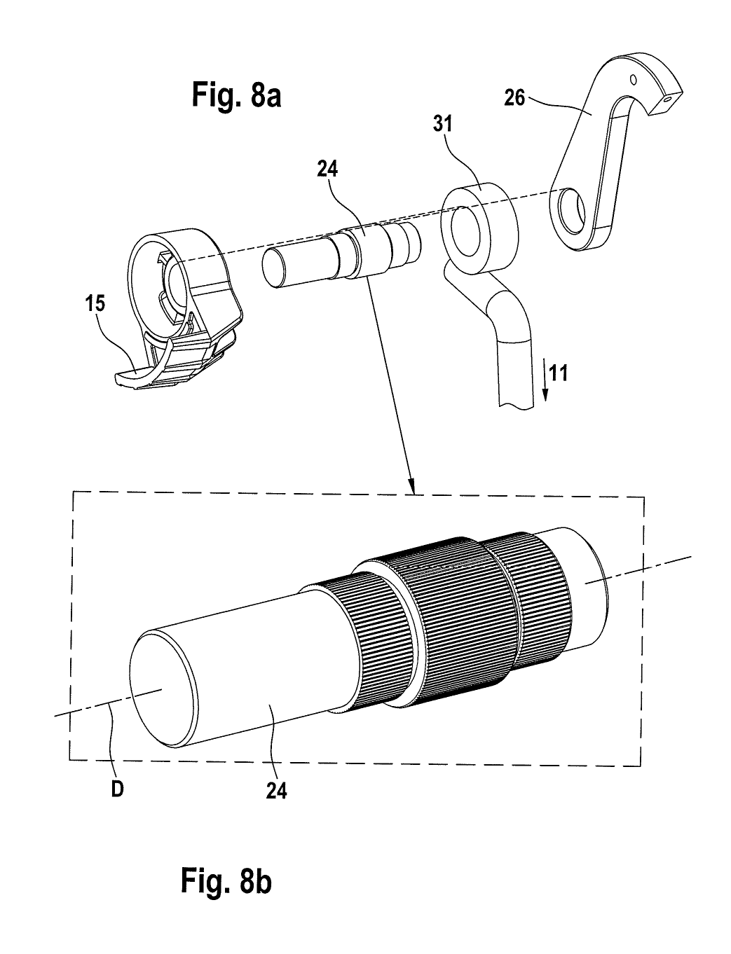

An important mounting step of the drive pedal unit 1 is shown in FIGS. 8a and 8b: the lever arm 26 is pressed onto the main shaft 24—together with the pedal lever 31 and the element which has the friction surface 15. The main shaft 24 has a roughened surface for a secure fit of the forced-on parts. The roughened surface consists of small longitudinal grooves which extend parallel to the longitudinal axis D. As a result, the components mentioned above are no longer able to rotate relative to one another and, as a result of this mounting, particularly small tolerances may be implemented.

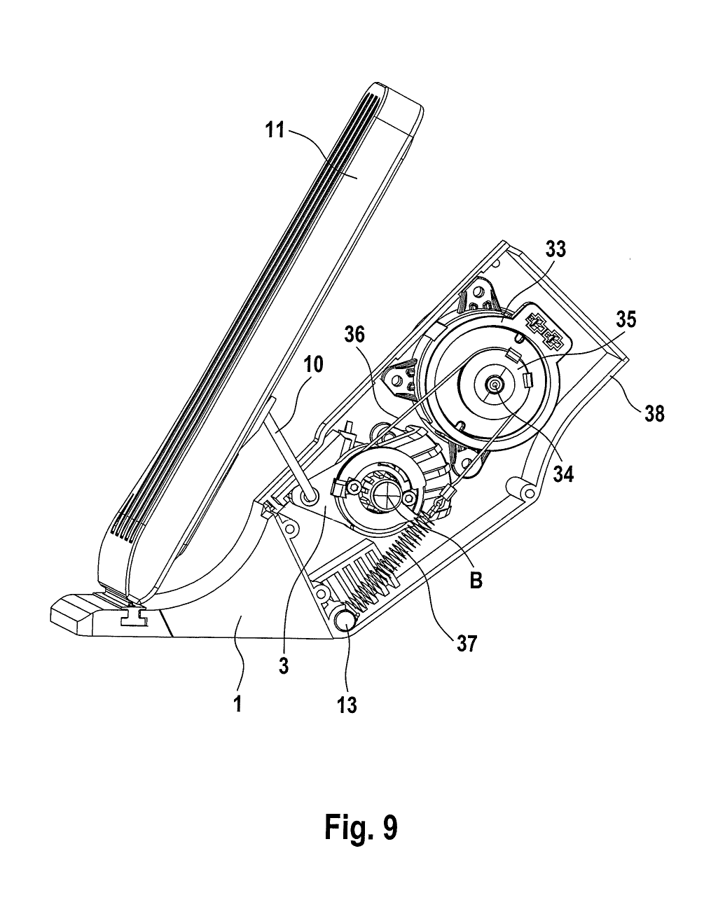

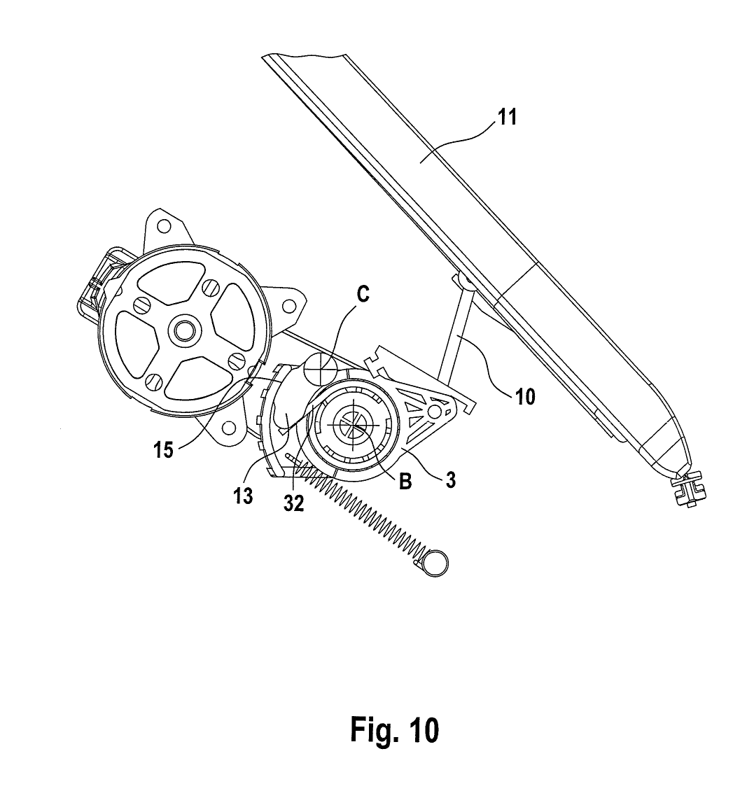

A further embodiment of the drive pedal unit 1 is shown in FIGS. 9 and 10. The components which have already been described in the previous embodiments are once again provided with the same reference numerals. In this case, the drive pedal unit 1 operates in the following manner: if the pedal plate 11 is depressed, the transmission element 10 is also actuated and the cam-like cam disk 3 starts to rotate about its rotational axis B. An electric motor 33 is controlled to generate an additional restoring force F_{Additional}. A disk 35 is positioned on the motor shaft 34 of the electric motor 33, said disk comprising a groove on its outer peripheral surface, in which a belt 36 is guided. The belt 36 is fastened, on the one hand, to the cam disk 3 and, on the other hand, via a spring 37 to the housing 38. By depressing the pedal plate 11, the cam disk 3 is rotated and starts to pull on the belt 36, which is tensioned by means of the spring 37 on the motor shaft 34. By controlling the electric motor 33, tension is applied to the belt 36 and a force transmitted to the cam disk 3 so that the transmission element 10 and the pedal plate 11 are returned to the starting position thereof. In other words, an additional restoring force F_{Additional} may be set. As already mentioned, this additional restoring force F_{Additional} may be generated in the form of vibrations or rectangular force impulses. Moreover, the maximum possible stroke S of the pedal plate 11 may be limited by a suitable additional restoring force F_{Restoring}.

The means for producing a hysteresis independently of the force generated by the electric motor 33 are again configured as a friction element 13 and a friction surface 15 cooperating with the friction element 13. The friction surface 15 is fixedly connected to the cam-like cam disk 3. By means of the fixed connection, the friction surface 15 rotates together with the cam disk 3 about the rotational axis B. A friction element 13 cooperates with the friction surface 15, said friction element being pivotably mounted about the axis C. The rotational axis C is arranged in parallel and spaced apart from the rotational axis B of the cam disk 3. As the cam disk 3 is connected via the transmission element 10 to the pedal plate 11, a frictional force applied to a friction surface 15 is transmitted to the movement of the pedal plate 11, i.e. such a frictional force damps the movement of the pedal plate 11. A torsion spring 32 presses the friction element 13 against the friction surface 15 and, with the movement of the friction surface 15 which is rotated together with that of the pedal plate 11, generates a frictional force.

As already mentioned, it is important that the hysteresis is generated independently of the additional restoring force F_{Additional} of the electric motor 33. This is achieved by the friction surface 15 and the friction element 13 being decoupled from the power flow between the electric motor 33 and the pedal plate 11. Instead, the friction surface 15 and the friction element 13 are arranged in parallel with said power flow, and thus independently of the additional restoring force F_{Additional} generated by the electric motor 33. It is also important that the hysteresis remains constant. In other words, the hysteresis has a constant characteristic curve, irrespective of whether the electric motor 33 is activated or not. The hysteresis behavior remains the same, irrespective of whether the electric motor 33 is active or is not activated.

As has already been illustrated with reference to FIG. 1, the torsion spring 32 is suspended in the cam disk 3 and is tensioned by a rotation of the cam disk 3. The other end of the torsion spring 32 bears against the friction element 13 and presses it against the friction surface 15. By means of the rotation of the cam disk 3, the torsion spring 32 is increasingly tensioned and presses the friction element 13 more firmly against the friction surface 15.

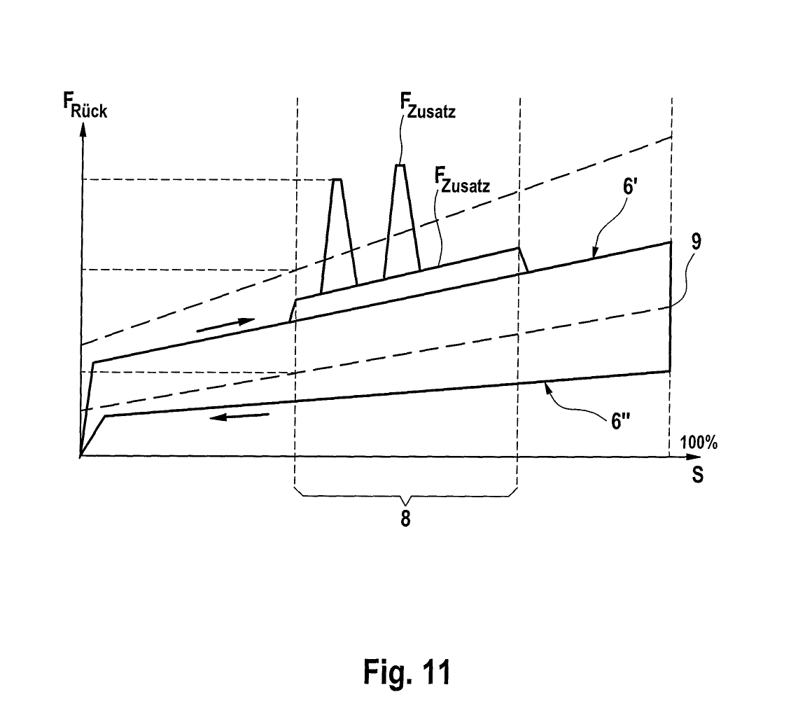

With reference to FIG. 11, the mode of operation of the disclosed exemplary embodiments is explained once again. In the pedal characteristic curve shown in FIG. 11, the restoring force F_{Restoring} is plotted relative to the stroke S of the pedal plate 11. The outgoing, passive pedal characteristic curve 6′ of the hysteresis jump 9, and the returning pedal characteristic curve 6″ have already been described with reference to FIG. 3. An additional restoring force F_{Restoring} may be produced by the drive pedal units 1 described, said additional restoring force serving to transmit information to the vehicle driver or guiding the vehicle driver in an economical driving mode. The range in which the electric motor actuators 18, 23, 33 are active and generate an additional restoring force F_{Additional} is provided with the reference is numeral 8. It is important, therefore, that said active range able to be moved over the entire abscissa. In other words, with each stroke S of the pedal plate between 0% and 100% an additional restoring force F_{Additional} may be generated in the form of vibrations, force peaks or rectangular force impulses. Limiting the stroke S by a force threshold is also possible in any position of the pedal plate 11.

### LIST OF REFERENCE NUMERALS

1 Drive pedal unit
2 Bearing surface
3 Cam-like cam disk
4 Torsion spring
5 Magnet
6′, 6″ Passive pedal characteristic curve
7 Magnet plunger
8 Active range
9 Hysteresis jump
10 Transmission element
11 Pedal plate
12 Control unit
13 Friction element
14 Axle pin
15 Friction surface
16 Sensor
17 Control unit
18 Lifting magnet
19 Housing
20
21
22 Bearing pin
23 Electric motor
24 Main shaft
25 Magnet
26 Lever arm
27 Sensor
28 Motor shaft
29 Circuit board
30 Spring
31 Pedal lever
32 Torsion spring
33 Electric motor
34 Motor shaft
35 Disk
36 Belt
37 Spring
38 Housing
A Axis—lifting magnet 18
B Rotational axis—cam disk 2
C Rotational axis—friction element 13
D Rotational axis—lever arm 26

1.-10. (canceled)

11. A drive pedal unit for motor vehicles, wherein a position change of the pedal plate brought about by a corresponding actuating force, with respect to the starting position thereof against a restoring force of a restoring spring, leads to an increase of the drive force of the engine and, when the actuating force decreases, the restoring force of the restoring spring returns the pedal plate in the direction of the starting position thereof, wherein an externally controllable electromechanical actuator is arranged such that an additional restoring force (F_{Additional}) may be set on the pedal plate, wherein hysteresis means are provided for producing a hysteresis of the pedal characteristic curve, and wherein the hysteresis is independent of the additional restoring force (F_{Additional}) of the electromechanical actuator.

12. The drive pedal unit as claimed in claim 11, wherein the hysteresis means are designed as a friction element and a friction surface cooperating with the friction element, wherein the friction surface is connected to the pedal plate, whilst the friction element is decoupled from the power flow between the pedal plate and the electromechanical actuator.

13. The drive pedal unit as claimed in claim 11, wherein the friction element is movably arranged about an axis (C), which is located parallel to an axis (B) of the friction surface.

14. The drive pedal unit as claimed in claim 13, wherein the friction element is pivotably arranged about an axle pin, wherein the axle pin is fastened in a housing of the drive pedal unit.

15. The drive pedal unit as claimed in claim 11, wherein the electromechanical actuator is configured as a linear lifting magnet, a plunger thereof bearing against a cam-like cam disk, wherein the cam disk is able to be actuated by means of a transmission element of the pedal plate.

16. The drive pedal unit as claimed in claim 15, wherein the cam-like cam disk carries at least one magnet, the motion thereof being able to be determined by a sensor.

17. The drive pedal unit as claimed in claim 12, wherein the electromechanical actuator is configured as an adjustable electric motor, which pretensions a rotary spring against a bearing pin, wherein a lever arm connected to the pedal plate bears against the bearing pin.

18. The drive pedal unit as claimed in claim 17, wherein the lever arm carries at least one magnet, the motion thereof being able to be determined by a sensor.

19. The drive pedal unit as claimed in claim 12, wherein the electromechanical actuator is configured as a reversible electric motor, a pretensioned belt bearing on the motor shaft thereof, said belt, on the one hand, being connected via a pretensioned spring to a housing of the drive pedal unit and, on the other hand, to a cam disk, wherein the cam disk is able to be actuated by means of a transmission element of the pedal plate.

20. The drive pedal unit as claimed in claim 11, wherein the additional restoring force (F_{Additional}) limits a maximum stroke (S) of the pedal plate, and generates force impulses or vibrations on the pedal plate.
